(19) United States
(12) Patent Application Publication
(10) Pub. No.: US 2008/0029033 A1
(43) Pub. Date: Feb. 7, 2008

(54) Fish Feed Apparatus for Underwater Feeding

(75) Inventors: Jeffrey Harrison, New Brunswick (CA); Phillip Dobson, New Brunswick (CA)

Correspondence Address: CARTER, DELUCA, FARRELL & SCHMIDT, LLP, 445 BROAD HOLLOW ROAD, SUITE 225, MELVILLE, NY, 11747, US

(73) Assignee: AQUACULTURE ENGINEERING GROUP LTD., DAWSON SETTLEMENT, NEW BRUNSWICK (CA)

(21) Appl. No.: 11/569,952

(22) PCT Filed: May 31, 2005
(86) PCT No.: PCT/CA05/00825

§ 371 Date: Dec. 1, 2006

(30) Foreign Application Priority Data
Jun. 2, 2004 (CA) 2,469,512

(51) Int. Cl. A01K 61/02

(52) U.S. Cl. 119/51.04

(57) ABSTRACT

The present invention provides for an apparatus for dispensing a slurry feed suitable for fish under the surface of an aqueous body, the apparatus comprising a housing having a feed inlet and radial feed dispensing means, means for providing a slurry containing a feed product to the feed inlet means in the housing and a radial feed dispensing means comprising a plurality of spaced-apart slurry dispensing outlets therein for dispensing slurry radially and outwardly from the housing under the water surface.

### FIELD OF THE INVENTION

This invention relates to a method and apparatus for dispensing feed, particularly feed used in aquaculture feeding.

### BACKGROUND OF THE INVENTION

There are numerous references in the patent literature relating to feeding equipment for fish that can be manually or automatically actuated.

In terms of feed dispensing equipment, it is highly desirable to provide a feed unit which is capable of providing feed over a large area for fish feeding—otherwise, multiple units have to be provided for a given area. Additional units add to the cost of a feed operation. Moreover, dispensing of feed is desirably carried out under the surface of an aqueous body, to avoid problems such as feed being taken by birds, insects, or other animals should the feed be dispensed on the surface of the aqueous body.

Submersible feeding units such as those taught in U.S. Pat. Nos. 4,235,198 and 5,138,979 are known; in these references, a food storage area in the unit taught by U.S. '198 is employed and feed is dispensed via passage 14 located beneath orifices 11. U.S. '979 discloses a unit having a body for retaining fish feed with the dispensing mechanism utilizing a single nozzle in the form of a metering head cooperating with an inner bushing surface.

U.S. Pat. No. 6,016,767 discloses a feeding arrangement suitable for one or more fish ponds where feed material is fed through a central shaft (FIG. 2) where a slurry is then passed through a distribution valve and delivered via individual conduits. There is no disclosure relating to the concept of a separate diffuser outlet for providing feed distribution over a large surface area.

Other references such as U.S. Pat. No. 6,192,380 disclose a pressurized underwater feed system utilizing only a single discharge nozzle (i.e. only a single dispensing source is taught). U.S. Pat. No. 6,070,554 teaches another type of system where a submersible feeder with a base located underwater dispenses feed into an area surrounded by mesh until the feed is consumed.

Another example of a different techniques for fish feeding is shown in Canadian patent number 2,387,535 where a feed hose utilizing an air stream as a carrier conveys fish food to a spreader that composed of a rotor and a single outlet that is rotatable. Further, Canadian patent number 2,126,406 teaches a system using air as a carrier where a blower projects feed through a single discharge tube.

Another concept utilizes a feeding system where the feed is placed on a rotating disc or plate in order to broadcast the feed above the water. In another above-water system, shown in U.S. Pat. No. 4,852,521, contemplates an auger system feeds fish food onto a rotating distributor.

The above all rely on above-water distribution techniques and as such have several disadvantages compared to below-surface dispersion—i.e. they are subject to wind and weather conditions which could result in uneven feed distribution and even loss of feed under sufficiently high wind conditions.

### SUMMARY OF THE INVENTION

The present invention is directed to an improved fish feeding apparatus and method relating thereto, where the apparatus is capable of providing a large distribution or dispersal of fish food in an under-water, sub-surface environment, which is comparable to a conventional distribution system which would normally be located above water.

More particularly, according to one aspect of the invention, there is provided an apparatus for dispensing a slurry feed suitable for fish under the surface of an aqueous body, the apparatus comprising a housing having a feed inlet and feed dispensing means, means for providing a slurry containing a feed product to the feed inlet in the housing; and feed dispensing means comprising at least one slurry dispensing channel for dispensing the feed radially upward and outward from the housing under the surface of the aqueous body.

In accordance with a further preferred aspect of the invention, there is provided an apparatus wherein the housing comprises an elongated chamber having an upper portion and a lower portion, the feed dispensing means being at the upper portion and being adapted to radially dispense a plurality of slurry streams containing the feed about the peripheral area extending outwardly from the upper portion of the housing.

Desirably, the housing has a throat portion and the feed dispensing means comprise a plurality of spaced-apart channels extending outwardly from the throat portion of the housing, the channels being arranged to balance the housing.

The channels preferably are trough-shaped, have a terminal end portion and means for deflecting feed projected from the outlet section in a downwardly extending direction.

Further preferred is that the apparatus includes a central axis and a directional thruster to permit the housing to rotate about the central axis, the directional thruster includes thrust diversion means adapted to permit the housing to change movement direction, the channels are equal in number and circumferentially arranged in a spaced-apart equidistant configuration.

It is further preferable the apparatus includes a flotation element coupled to the housing to float at or near the surface of the aqueous body, a ballast is adapted to stabilize the apparatus when dispensing the feed, and the feed is a slurry feed.

In another preferred aspect of the present invention there is provided a fish feeding device comprising:
a hollow floatable housing having an upper portion including dispensing means for dispensing fish feed and a lower portion including an inlet for receiving the fish feed and an outlet in fluid communication with the dispensing means; the dispensing means having a throat portion, at least one channel for dispensing the fish feed and being mounted to the outlet; and,
a source of fish feed operably connected to the inlet.

Desirably, the channel comprises a plurality of channels equilaterally spaced from each other, the channel extends from the throat portion and the throat portion is mounted to the outlet of the lower portion, and the channel includes a terminal end for dispensing the slurry arcuately upward relative to a horizontal plane of the upper portion of the housing.

It is further preferred that the terminal ends are adapted to effect a welling upwardly of water as the fish feed is being dispensed from the channel such that the feed is near but beneath the surface of the water, the terminal ends have a lower wall and an upper wall and the lower wall and upper wall are adapted to be positioned at an angle of between 2° and 50° relative to the horizontal plane of the upper portion of the housing, and that the terminal ends have a lower wall and an upper wall and the lower wall and upper wall are adapted to be positioned at an angle of between 3° to 25° relative to the horizontal plane of the upper portion of the housing.

Desirably, the housing includes anchor means for anchoring the housing in position within a body of water, the housing includes a protective screen to prevent fish from contacting the housing, the housing includes a control means adapted to permit diversion of the direction of thrust for the housing, and the control means is a body coupled to the upper portion of the housing.

It is further preferable the upper portion has a peripheral edge and the body is a channel end portion movable about the peripheral edge of the upper portion such that direction thrust of the unit can be manipulated.

Moreover, it is preferable the channel end portion is arcuately curved to receive the feed dispensed from said channels.

Additionally, it is desirable the movement of the unit in the water is remotely controlled by a user, the housing further includes anti-icing elements, the housing is adapted to accommodate ballast for stabilizing the housing, and the dispensing of feed and movement of the housing is automated.

In yet another aspect of the present invention, there is provided a method of dispensing a slurry feed suitable for feeding fish, the method comprising the steps of:
providing a source of a slurry containing a feed product in a housing;
passing the slurry through the housing and permitting the slurry to exit from the housing in a radially outward flow through divided slurry feed streams; and
dispersing the separate slurry streams rotatably directly beneath or at the surface of an aqueous body.

### BRIEF DESCRIPTION OF DRAWINGS

Having thus generally described the invention, reference may now be made to the accompanied drawings, which illustrate preferred embodiments only, and in which

FIG. 1 is a side elevational view of the feed distribution apparatus of the present invention, shown in cross-section;

FIG. 2 is a top plan view of a feed distribution apparatus of FIG. 1;

FIG. 3 is a view similar to similar FIG. 2 showing the distribution unit in use;

FIG. 4 is a top plan view of a modified feed distribution unit; and,

FIG. 5 is a partial elevational view, shown in section, of the apparatus of FIG. 4.

### DETAILED DESCRIPTION OF THE DRAWINGS

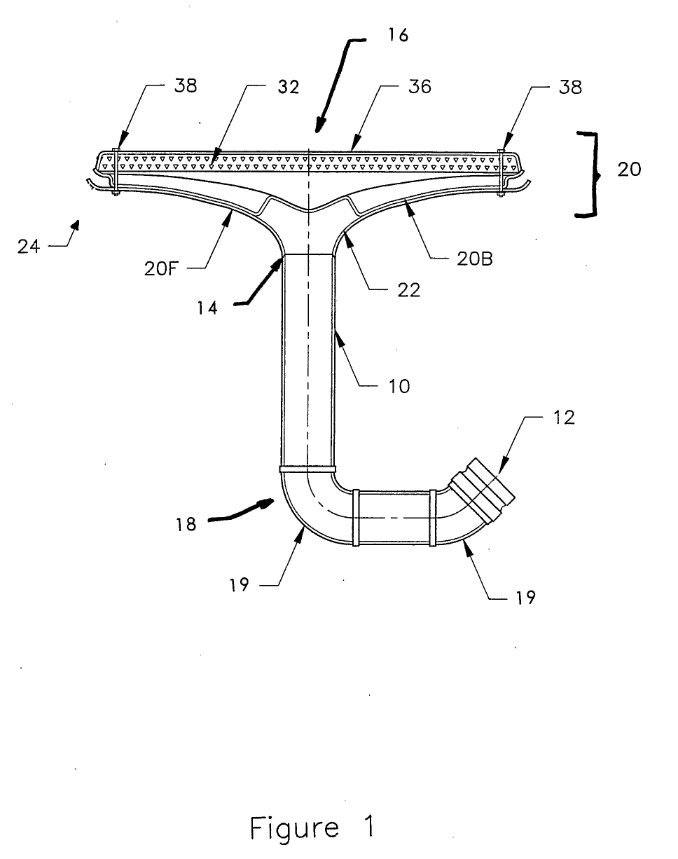

Referring initially to FIG. 1, the apparatus for dispensing fish feed is illustrated and includes a central housing 10 which is normally oriented in a vertical condition when in use. The housing 10 is a hollow feeding chamber having an inlet 12 and an outlet 14 at the upper portion 16 of the housing or unit 10. The chamber or housing can be of any dimension, lengthwise and widthwise, that is appropriate for the aquatic area being served by the unit. In typical applications the diameter could range from about 1 inch to 8-10 inches. However, again, these dimensions are determined based on the application of the unit.

The inlet 12 is illustrated as being positioned in the lower end 18 of the unit having a generally U-shaped configuration. Other positions, such as the inlet 12 horizontal to the upper portion 16 of the unit can also be used depending on the nature of the aqueous body in which the unit is to be located. Further, the U-shape configuration is used to provide desirable flow characteristics but other configurations can be used. A source of fish feed (not shown) is attached to the inlet 12 and a pump (not shown) is used to pump the feed into the unit. Any conventionally known means for coupling the inlet 12 and pumping the source of fish feed can be used. For example, a pipe, hose or other means can be coupled to the inlet 12 by way of a threaded end. The pump (not shown) can pump the feed into the unit at the appropriate pressure for distribution through the outlet 14 of the unit 10.

It will be understood by those skilled in the art that the unit should be of a configuration such that the desired flow characteristics of the feed are achieved. Further, the source of feed is generally in a slurry form to be fed through the unit 10. Accordingly, the inlet 12 preferably includes rounded corners 19 which enhance the flow of the feed and prohibit the chamber 10 from becoming plugged.

A dispensing means 20 is mounted on the outlet 14. The dispensing means 20 includes a throat portion 22 and at least one channel or nozzle 20a provided in the upper portion 16 is contemplated. However, it is preferred that a plurality of channels 20a, 20b, etc. be in fluid communication with the throat 22.

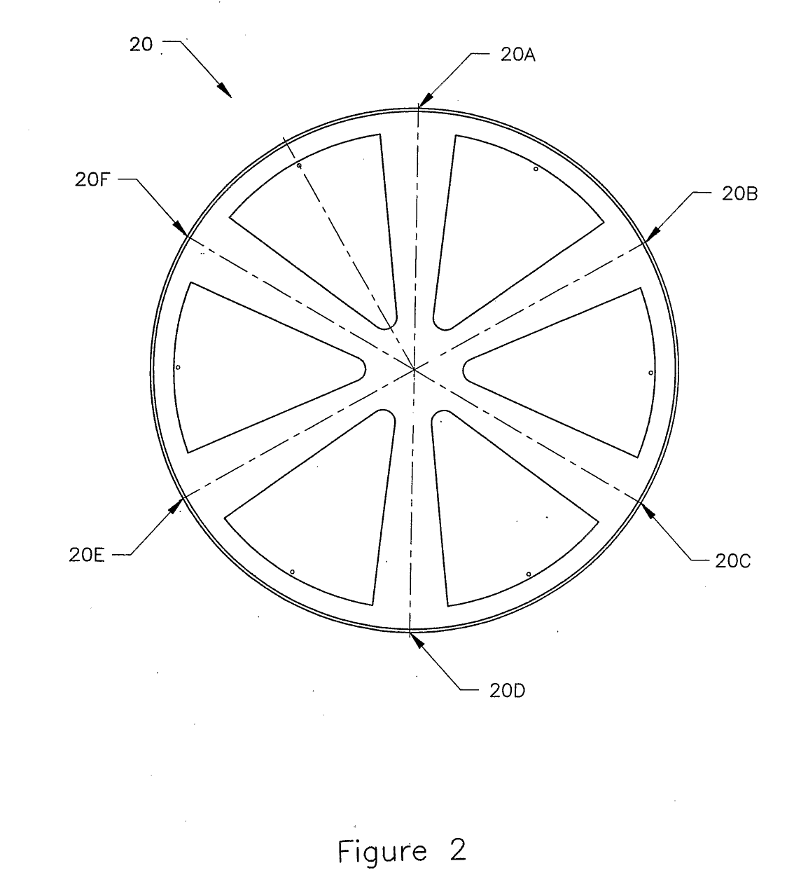

Turning to FIG. 2 it can be seen that the upper portion 16 includes a dispensing means 20 including a plurality of nozzles 20a, 20b, etc. diverging from the throat portion 22 is preferred. Each nozzle 20a, 20b, etc. is designed to disperse a similar amount of feed; the nozzles being connected together at the upper portion 16 of the housing 10 through a generally T-shaped throat 22 that splits off into the desired number of nozzles 20a, 20b, etc. Obviously, the throat 22 is also designed for smooth arcuate contours in order to aid the flow of the slurry feed in the desired manner and avoid blocking of the housing chamber 10.

Each nozzle 20 includes a terminal end 24 (see FIG. 1) which can be of any geometric configuration that ranges from a generally circular opening (in cross-section) to elongated openings and the like. It is preferred that the opening of the terminal end 24 is dimensioned so that the slurry feed is readily dispersed in the peripheral area around the apparatus without possibility of the channel 20a, 20b, etc. becoming blocked and also to provide the necessary flow velocity. For an efficient operation, the terminal end 24 are designed for feed to be spread in a non-overlapping pattern. Moreover, a preferred operation of the apparatus includes the slurry being radially dispersed from the channels 20a, 20b, etc. in a pattern that extends outwardly and upwardly from the terminal ends 24 such that surface agitation is created but where the feed remains beneath the water surface 26.

The number of discharge orifices or terminal ends 24 will vary depending on the nature of the feed to be dispersed, the area of the aqueous body, and other factors which include desired flow velocities, etc. The nozzles 20 will also be arranged to ensure a balanced terminal end 24 configuration where the terminal ends 24 are positioned in a spaced-apart manner so that the force exerted by each of the nozzles 20 is substantially neutral. For example, two or more terminal ends 24 can be employed where each is arranged in a diametrically opposed relationship; in the case of three terminal ends 24, preferably the geometric arrangement is such that the terminal ends 24 are in a generally triangular configuration. The number of terminal ends 24 can be as many as twelve or more for a large slurry feeding distribution apparatus. Alternatively, there can be as few as two terminal ends 24 in the case of smaller aqueous bodies or fish types.

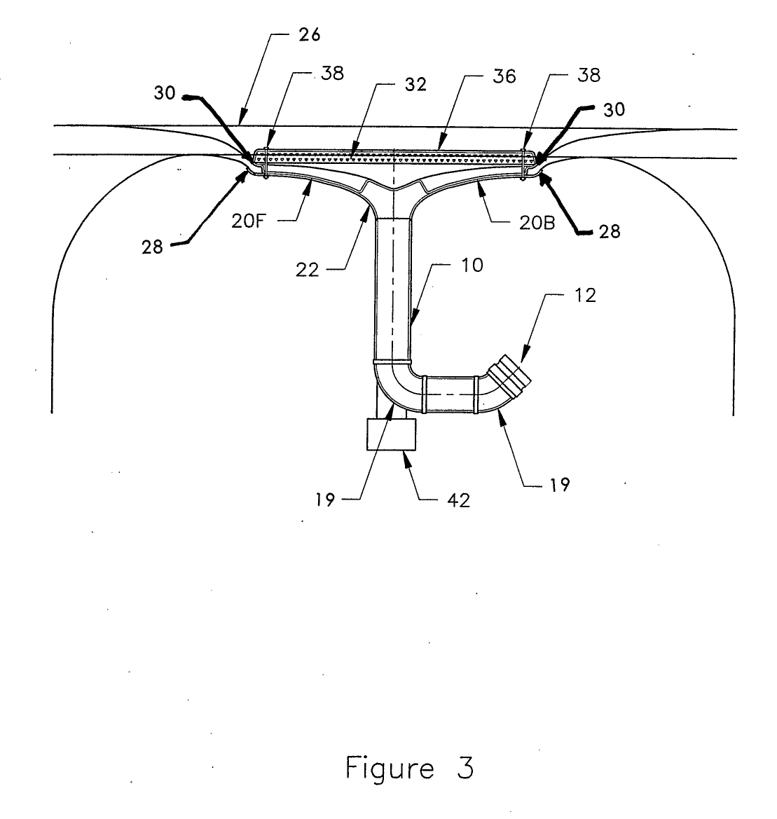

It will be seen from the drawings, and from FIG. 3 more specifically, that the terminal ends 24 can be oriented such that the slurry feed flow from the orifices is generally oriented upwardly from the upper portion 16 of the housing. The upward motion of the slurry feed is accomplished by the terminal ends 24 of the channels 20 being arcuately contoured. The angle between the horizontal plane of the housing 10 on the lower wall 28 of the nozzles 20a, 20b, etc. and the vertical plane of the housing 10 being such that the feed slurry can be directed in an outwardly extending direction above the horizontal plane. Different types of feeds or different sizes of feeds used with the apparatus will determine the appropriate angle of the terminal ends 24. Typically, the terminal ends 24 of the nozzles 20a, etc. have an angle of between 2° to 50° between the lower side wall 28 and the upper wall 30 and more desirably 3° to 25° relative to the horizontal plane of the dispensing means 20. This angle also varies depending on the positioning of the unit within the aqueous body of water and the amount of water intended to lie above the terminal ends 24.

As mentioned above, the body of water in which the apparatus will reside can be correlated to the angle of discharge from the nozzles 20a, 20b, etc. so as to effect a “welling up” of the water and feed mixture outwardly from the nozzles 20 without the nozzles 20 being at an angle that would cause the feed slurry to break through the water level 26.

The apparatus includes a flotation means 32 for buoyancy in the water body it is residing. The flotation means is designed to maintain the fish feed apparatus at a desired level in the water. More specifically, the flotation means 32 can be configured to float with only the upper portion 16 of the apparatus being visible in the water or it can be positioned slightly below the surface 26 of the water depending on the application. The flotation means 32 can be made of any suitable material such as foam, air bladders, etc. and can also be positioned in any suitable area on the apparatus. For example, the device can also be positioned on the inlet 12 or at the terminal ends 24.

Ideally, a cover means 36 can be provided if desired in order to add further structural integrity to the fish feed apparatus or simply to include a flotation device 32 thereon. Additionally, the cover means 36 can be positioned to assist with balance of the apparatus while in use in the water. The cover means 36, which can be of any suitable configuration, can be rigid or flexible and suitable material. Optionally, the cover means 32 can be anchored to the feed nozzles 20a, 20b, etc. by appropriate means such as by screws 38 or the like.

The housing 10 can include a protective screen or border (not shown) to prevent fish from contacting the housing 10 and disrupting flow of the feed. Further, with reference to FIG. 3, it can be seen that the fish feed apparatus can be positioned in the body of water beneath the water surface 26 by way of a weight means 42 configured to adequately weight the housing 10 the desired distance from the surface 26. The weight means 42 can take various forms and can even be anchored to the bottom of the aqueous body by using conventional weights or cement blocks in deeper water. In applications where the body of water is significantly deep, for example, the apparatus can be also anchored in place by bottom anchors.

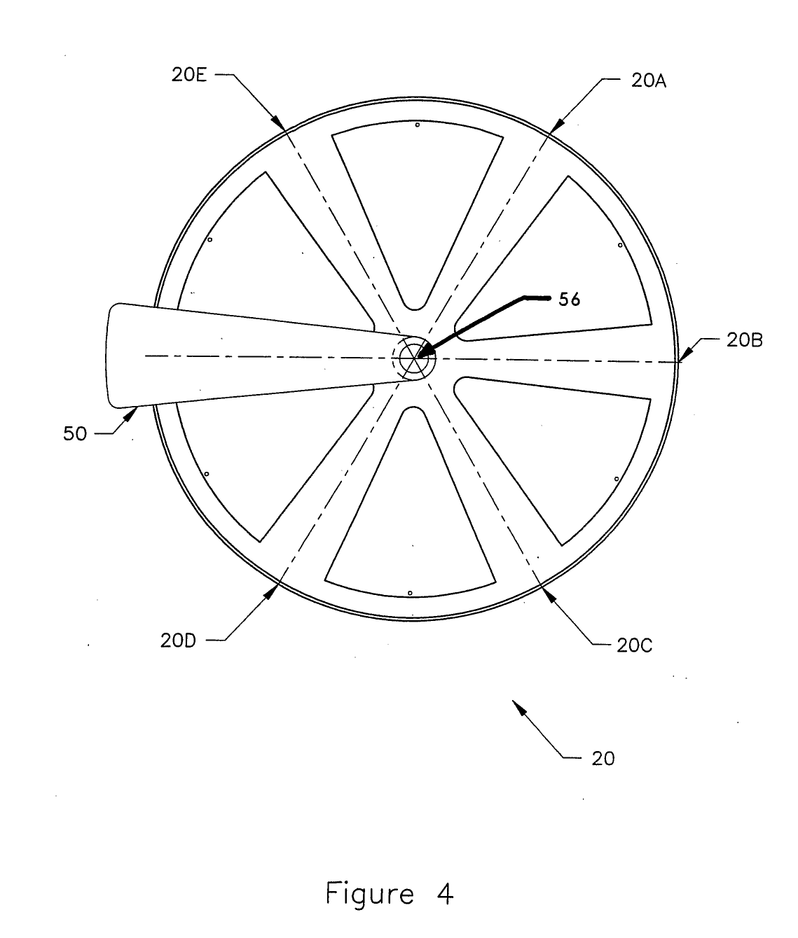

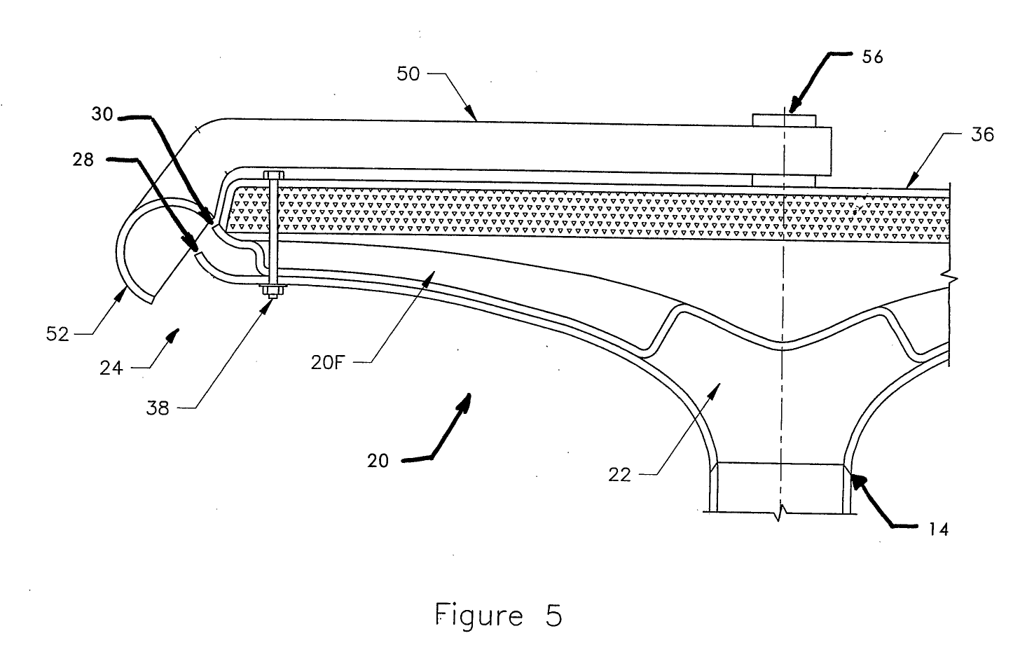

Another optional feature is illustrated in FIG. 4 and FIG. 5 where, if desired, the apparatus is designed to move about a body of water by way of a directional control means 50 operating in conjunction with one of the terminal ends 24 for the slurry feed. In particular, U-shaped body 50 is illustrated as being mounted to the upper portion 16 of the apparatus and the body 50 includes a channel end portion 52 angularly disposed with respect to the main body or housing 10. The disposition of the channel end portion 52 is such that it includes means 50, 56 adapted to permit diversion of the thrust for the unit direction designed to receive and displace the flow of slurry in a downwardly and rearwardly extending orientation from one of the nozzles 20a, 20b, etc. In this way, the apparatus may move about the surface 26 of a body of liquid so as to permit a greater area to be fed using a single apparatus. The degree of movement can be controlled by the length of any tethering device (not shown) attached to the diffuser or body 50 and the degree of movement permitted by the tethering device. The diffuser or body 50 can be coupled to the apparatus by conventional coupling means 56 such that the diffuser body 50 is fixed in place or alternatively can pivot or rotate along or around the unit 10, e.g. the upper portion 16.

In another optional embodiment of the present invention, the apparatus may include remote control means (not shown) operatively mounted in or on the unit to permit the unit to be displaced/moved to different locations. In such a case, the unit need not be provided with anchoring or tethering means; such remote control means are well known for different purposes and can be pre-programmed to cover pre-defined and predetermined patterns. Thus, a suitable motor (not shown) can be provided, connected to a drive means (not shown) for propelling the unit.

For use in climates where ice conditions may be of a concern, the unit can be provided with suitable anti-icing features such as electrical heaters (not shown) built into the apparatus which are adapted to be turned on when icing conditions are encountered. The apparatus of this invention can be provided with battery means (not shown) which can be actuated remotely to effect de-icing when such conditions are encountered. To that end, remote telemetry can also be employed to indicate to a central control (such as a CPU) that icing conditions have been encountered and either the de-icing is remotely activated by manual or automated means.

Moreover, the unit can be adapted to accommodate a ballast (not shown) to stabilize the unit when in use.

The apparatus of the present invention can be made from various types of materials. Depending on the environment in which the apparatus is intended to be located, suitable materials include metals of various types, plastics, etc.

1. An apparatus for dispensing a feed suitable for fish under the surface of an aqueous body, said apparatus comprising:
a housing having a feed inlet and feed dispensing means;
means for providing a slurry containing a feed product to said feed inlet in said housing; and
said feed dispensing means comprising at least one slurry dispensing channel for dispensing said feed radially upward and outward from said housing beneath the surface of said aqueous body.

2. The apparatus as defined in claim 1, wherein said housing comprises an elongated chamber, an upper portion and a lower portion, said feed dispensing means positioned at said upper portion and adapted to radially dispense a plurality of streams containing said feed about the peripheral area of said housing.

3. The apparatus as defined in claim 2, wherein said housing has a throat portion and said feed dispensing means comprise a plurality of spaced-apart channels extending outwardly from said throat portion of said housing, said channels arranged to balance said housing.

4. The apparatus as defined in claim 3, wherein said channels are trough-shaped, have a terminal end portion and means for deflecting feed projected from the terminal end portion in a downwardly extending direction.

5. The apparatus as defined in claim 1, said apparatus further includes a central axis and a directional thruster rotatable about said central axis.

6. The apparatus as defined in claim 5, wherein said directional thruster includes thrust diversion means adapted to permit said housing to change movement direction.

7. (canceled)

8. The apparatus as defined in claim 1, further including a flotation element coupled to said housing to float at or near the surface of said aqueous body.

9-10. (canceled)

11. A fish feeding device comprising:
a hollow floatable housing having an upper portion including dispensing means for dispensing fish feed and a lower portion including an inlet for receiving the fish feed and an outlet in fluid communication with said dispensing means; said dispensing means having a throat portion, at least one channel for dispensing the fish feed and being mounted to said outlet; and,
a source of fish feed operably connected to said inlet.

12. The apparatus as defined in claim 11, wherein said channel comprises a plurality of channels equilaterally spaced from each other.

13. The apparatus as defined in claim 11, wherein said channel extends from said throat portion and said throat portion is mounted to said outlet of said lower portion.

14. The apparatus as claimed in claim 13, wherein said channel includes a terminal end for dispensing said slurry arcuately upward relative to a horizontal plane of the upper portion of the housing.

15. The apparatus as claimed in claim 14, wherein said terminal ends are adapted to effect a welling upwardly of water as the fish feed is being dispensed from the channel such that the feed is near but beneath the surface of the water.

16-17. (canceled)

18. The apparatus as claimed in claim 11, wherein said housing includes anchor means for anchoring the housing in position within a body of water.

19. The apparatus as claimed in claim 11, wherein said housing includes a protective screen to prevent fish from contacting said housing.

20. The apparatus as claimed in claim 11, wherein said housing includes a control means adapted to permit diversion of the direction of thrust for the housing.

21. (canceled)

22. The apparatus as claimed in claim 11, wherein said upper portion has a peripheral edge and said body is a channel end portion movable about the peripheral edge of said upper portion such that direction thrust of the unit can be manipulated.

23. (canceled)

24. The apparatus as claimed in claim 11, wherein the device is capable of movement unit in water, and is remotely controlled by a user.

25. (canceled)

26. The apparatus as claimed in claim 11, wherein said housing is adapted to accommodate ballast for stabilizing the housing.

27. The apparatus as claimed in claim 24, wherein the dispensing of feed and movement of said housing is automated.

28. A method of dispensing a slurry feed suitable for feeding fish, said method comprising the steps of:
providing a source of a slurry containing a feed product in a housing;
passing said slurry through said housing and permitting said slurry to exit from said housing in a radially outward flow through divided slurry feed streams; and
dispersing said separate slurry streams rotatably directly beneath or at the surface of an aqueous body.
